(19) United States
(12) Patent Application Publication
(10) Pub. No.: US 2023/0139106 A1
(43) Pub. Date: May 4, 2023

(54) CONVERSION METHOD AND APPARATUS FOR DEEP LEARNING MODEL, SERVER, AND STORAGE MEDIUM

(71) Applicant: SHENZHEN CORERAIN TECHNOLOGIES CO., LTD., Guangdong (CN)

(72) Inventors: Chao XIONG, Guangdong (CN); Kuen Hung TSOI, Guangdong (CN); Xinyu NIU, Guangdong (CN)

(21) Appl. No.: 17/791,373

(22) PCT Filed: Jan. 5, 2021
(86) PCT No.: PCT/CN2021/070223

§ 371 Date: Dec. 21, 2022

(30) Foreign Application Priority Data
Jan. 7, 2020 (CN) 202010015495.0

(51) Int. Cl. G06N 3/04; G06N 3/08

(52) U.S. Cl. CPC G06N 3/04; G06N 3/08

(57) ABSTRACT

Provided are a conversion method and apparatus for a deep learning model, a server, and a storage medium. The method includes: parsing a target deep learning model into an intermediate representation of an instruction set computation graph; converting the intermediate representation of the instruction set computation graph into an intermediate representation of a data flow computation graph; adjusting the intermediate representation of the data flow computation graph to an intermediate representation of a customized architecture; and obtaining a converted target data flow network model corresponding to the target deep learning model according to the intermediate representation of the customized architecture.

This application claims priority to Chinese Patent Application No. 202010015495.0 filed with the China National Intellectual Property Administration (CNIPA) on Jan. 7, 2020, the disclosure of which is incorporated herein by reference in its entirety.

### TECHNICAL FIELD

Embodiments of the present application relate to deep learning technology, for example, a conversion method and apparatus for a deep learning model, a server and a storage medium.

### BACKGROUND

A deep learning network is generally trained by algorithms. In most cases, an algorithm developer tends to use an open deep learning framework for model training. One deep learning framework may develop multiple deep learning models, and most open deep learning frameworks are designed for computing devices such as a central processing unit/graphics processing unit (CPU/GPU). The CPU/GPU uses a conventional instruction set architecture with relatively low architecture efficiency, relatively small operator granularity and relatively high flexibility. With the development of deep learning-related technology, a requirement for computing power is increasing. A defect of the architecture efficiency of the conventional instruction set cannot meet a requirement of an application scenario. In contrast, a data flow architecture has higher efficiency and is more suitable for a development trend of deep learning technology from the perspective of technical route. However, large differences between the data flow architecture and the instruction set architecture exist in data representation. The data flow architecture has much larger operator granularity than the instruction set architecture, and before the operator granularity of the data flow architecture is calculated, an order of calculation modules is predetermined according to data dependence. This difference determines that a model trained under the instruction set architecture cannot be directly deployed in the data flow architecture, significantly hindering the application development of the data flow architecture.

### SUMMARY

Embodiments of the present application provide a conversion method and apparatus for a deep learning model, a server and a storage medium so that a deep learning model developed based on an instruction set architecture is converted to operate under a data flow architecture.

In an embodiment, the embodiments of the present application provide a conversion method for a deep learning model. The method includes the steps below.

A target deep learning model is parsed into an intermediate representation of an instruction set computation graph.

The intermediate representation of the instruction set computation graph is converted into an intermediate representation of a data flow computation graph.

The intermediate representation of the data flow computation graph is adjusted to an intermediate representation of a customized architecture.

A converted target data flow network model corresponding to the target deep learning model is obtained according to the intermediate representation of the customized architecture.

In an embodiment, the embodiments of the present application provide a conversion apparatus for a deep learning model. The apparatus includes a target deep learning model parsing module, an instruction set computation graph intermediate representation conversion module, a data flow computation graph intermediate representation adjustment module and a target data flow network model generation module.

The target deep learning model parsing module is configured to parse a target deep learning model into an intermediate representation of an instruction set computation graph.

The instruction set computation graph intermediate representation conversion module is configured to convert the intermediate representation of the instruction set computation graph into an intermediate representation of a data flow computation graph.

The data flow computation graph intermediate representation adjustment module is configured to adjust the intermediate representation of the data flow computation graph to an intermediate representation of a customized architecture.

The target data flow network model generation module is configured to obtain a target data flow network model corresponding to the target deep learning model according to the intermediate representation of the customized architecture.

Optionally, the target deep learning model includes first operator granularity, the intermediate representation of the instruction set computation graph includes second operator granularity, and the intermediate representation of the data flow computation graph includes third operator granularity.

Optionally, the first operator granularity is the same as the second operator granularity.

Optionally, the second operator granularity is less than the third operator granularity.

Optionally, the intermediate representation of the instruction set computation graph further includes a second operator, and the intermediate representation of the data flow computation graph further includes a third operator.

Optionally, second operators form the third operator through fusion.

In an embodiment, the embodiments of the present application provide a server. The server includes one or more processors and a storage apparatus configured to store one or more programs.

The one or more programs, when executed by the one or more processors, cause the one or more processors to implement the method according to any embodiment of the present application.

In an embodiment, the embodiments of the present application provide a computer-readable storage medium storing a computer program, where the computer program, when executed by a processor, implements the method according to any embodiment of the present application.

In the embodiments of the present application, the target deep learning model is parsed into the intermediate representation of the instruction set computation graph; the intermediate representation of the instruction set computation graph is converted into the intermediate representation of the data flow computation graph; the intermediate representation of the data flow computation graph is adjusted to the intermediate representation of the customized architecture; and the converted target data flow network model corresponding to the target deep learning model is obtained according to the intermediate representation of the customized architecture. Therefore, the deep learning model developed based on the instruction set architecture is converted to operate under the data flow architecture. The intermediate representation of the instruction set computation graph, the intermediate representation of the data flow computation graph and the intermediate representation of the customized architecture are used for describing the deep learning model, which may make a design more flexible through a tradeoff in readability and execution efficiency according to an actual requirement.

### BRIEF DESCRIPTION OF DRAWINGS

FIG. 1 is a flowchart of a conversion method for a deep learning model according to embodiment one of the present application.

FIG. 2 is a structure diagram of a conversion apparatus for a deep learning model according to embodiment two of the present application.

FIG. 3 is a structure diagram of a server according to embodiment three of the present application.

### DETAILED DESCRIPTION

The present application is further described in detail hereinafter in conjunction with the drawings and embodiments. It is to be understood that the embodiments described herein are intended to illustrate and not to limit the present application. Additionally, it is to be noted that to facilitate description, only part, not all, of structures related to the present application are illustrated in the drawings.

Some example embodiments are described as processing or methods depicted in flowcharts. Although multiple steps are described as sequential processing in the flowcharts, many of the steps may be implemented concurrently, coincidentally or simultaneously. Additionally, the sequence of the multiple steps may be rearranged. The processing may be terminated when the operations of the multiple steps are completed, but the processing may further have additional steps that are not included in the drawings. The processing may correspond to a method, a function, a procedure, a subroutine, a subprogram or the like.

Additionally, the terms “first”, “second” and the like may be used herein to describe multiple directions, actions, steps, elements or the like, but these directions, actions, steps or elements are not limited by these terms. These terms are only used for distinguishing one direction, action, step or element from another direction, action, step or element. For example, without departing from the scope of the present application, first operator granularity may be referred to as second operator granularity, and similarly, the second operator granularity may be referred to as the first operator granularity. Both the first operator granularity and the second operator granularity are operator granularity but not the same operator granularity. Terms like “first”, “second” and the like are not to be construed as indicating or implying relative importance or implicitly indicating the number of technical features as indicated. Thus, a feature defined as a “first” feature or a “second” feature may explicitly or implicitly include one or more of such features. As described herein, “multiple” is defined as at least two, for example, two, three or the like, unless otherwise expressly limited.

### Embodiment One

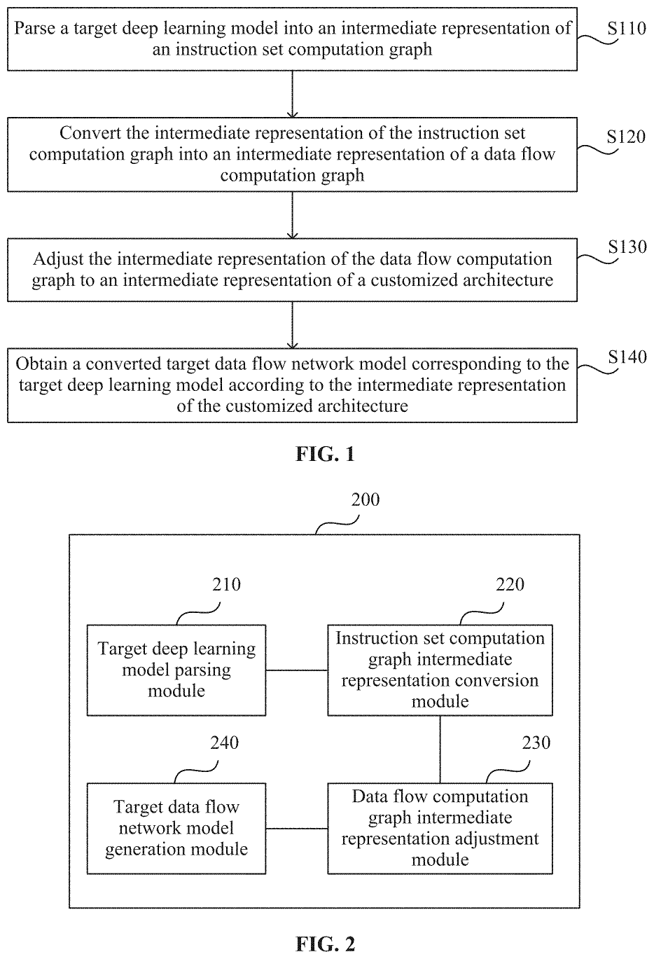

FIG. 1 is a flowchart of a conversion method for a deep learning model according to embodiment one of the present application. The method may be applicable to a case in which a deep learning model developed based on an instruction set architecture is input into a chip based on a data flow architecture to operate and may be performed by a conversion apparatus for a deep learning model. The apparatus may be implemented in software and/or hardware and integrated on a server.

As shown in FIG. 1, the conversion method for a deep learning model according to embodiment one of the present application includes the steps below.

In S110, a target deep learning model is parsed into an intermediate representation of an instruction set computation graph.

In an embodiment, a deep learning framework includes a large amount of base codes for an algorithm developer to perform model training such as TensorFlow, Caffe, Mxnet, Torch and the like. A deep learning model is a neural network model developed under the deep learning framework to implement a specific algorithm, and one deep learning framework may develop multiple deep learning models. A set of all instructions that CPU/GPU can execute is referred to as an instruction set, and an instruction set architecture is an interface between CPU/GPU physical hardware and higher-level software. Most open deep learning models are designed for computing devices such as the CPU/GPU, that is, most open deep learning models use the instruction set architecture.

The intermediate representation of the instruction set computation graph defines a network structure of the deep learning model, that is, types of operator and a connection relationship between operators. An operator is composed of one or more minimum operation units that can be executed by a target operation device. The connection relationship between operators represents an operation rule between the operators. Operator granularity represents a complexity of the operator and is generally represented by the number of minimum operation units included in the operator granularity, where an operator with large operator granularity is referred to as a large-granularity operator, and an operator with small granularity is referred to as a small-granularity operator. For example, in a CPU/GPU device, minimum operation units are A1, A2, A3 and A4, and operators are also A1, A2, A3 and A4. Then, corresponding operator granularity equals to 1, and there are four types of operator: A1, A2, A3 and A4. A connection relationship between operators may be that (A1+A2) is operated first and then (A1+A2+A3+A4) is operated. The deep learning model using the instruction set architecture generally includes the small-granularity operator with relatively small granularity, relatively high flexibility and low efficiency. When data to be computed is too large in volume, a relatively long computation time is needed.

The target deep learning model is parsed into the intermediate representation of the instruction set computation graph, that is, types of operator and an operation rule between operators of the target deep learning model are parsed out so that the operators in the target deep learning model developed based on the instruction set architecture can be fused and converted and the target deep learning model can be operated under a data flow framework.

Operator granularity of the target deep learning model is first operator granularity, and operator granularity of the intermediate representation of the instruction set computation graph is second operator granularity. Since the operator granularity is not varied when the target deep learning model is parsed into the intermediate representation of the instruction set computation graph, the first operator granularity is the same as the second operator granularity, and an operator in the target deep learning model is also the same as an operator in the intermediate representation of the instruction set computation graph, each of which is a first operator. That is, in the intermediate representation of the instruction set computation graph, the second operator granularity is obtained for the first operator. That is, the operator/operator granularity of the target deep learning model is consistent with the operator/operator granularity of the intermediate representation of the instruction set computation graph. Moreover, the intermediate representation of the instruction set computation graph is closest to a representation of an original computation graph of the target deep learning model.

In an embodiment, the first operator/first operator granularity is closer to a design level of a neural network algorithm and has relatively high readability, facilitating a developer interpreting a network structure.

In S120, the intermediate representation of the instruction set computation graph is converted into an intermediate representation of a data flow computation graph.

In an embodiment, the intermediate representation of the data flow computation graph represents types of operator and a connection relationship between operators under the data flow architecture. The operator in the intermediate representation of the instruction set computation graph is the first operator, and an operator in the intermediate representation of the data flow computation graph is a second operator. The intermediate representation of the instruction set computation graph is converted into the intermediate representation of the data flow computation graph, that is, the intermediate representation of the instruction set computation graph is reconstructed according to operator granularity of a data flow, and the first operator in the intermediate representation of the instruction set computation graph is fused into the second operator in the intermediate representation of the data flow computation graph according to the operator granularity of the data flow, that is, small-granularity operators in the intermediate representation of the instruction set computation graph are fused into a large-granularity operator. For example, in the intermediate representation of the instruction set computation graph, there are four types of operator: A1, A2, A3 and A4. A connection relationship between operators may be that (A1+A2) is operated first and then (A1+A2+A3+A4) is operated. When the intermediate representation of the instruction set computation graph is converted into the intermediate representation of the data flow computation graph, (A1+A2) (A1 and A2 are small-particle operators) is fused into B (B is a large-particle operator), and (A3+A4) is fused into C. In this case, B has operator granularity of 2. In the intermediate representation of the data flow computation graph, there are two types of operator: B and C, and a connection relationship between the operators is (B+C).

In an embodiment, the fusion here does not mean simple superimposition, but includes meanings of fusion and conversion.

The intermediate representation of the data flow computation graph includes third operator granularity, and the third operator granularity included in the intermediate representation of the data flow computation graph is larger than the second operator granularity included in the intermediate representation of the instruction set computation graph.

In S130, the intermediate representation of the data flow computation graph is adjusted to an intermediate representation of a customized architecture.

In an embodiment, the intermediate representation of the customized architecture represents operators in the data flow architecture operating the target deep learning model and a connection relationship between the operators. The intermediate representation of the data flow computation graph is adjusted to the intermediate representation of the customized architecture, that is, the operator in the intermediate representation of the data flow computation graph is reconstructed and rewritten according to a design principle of the data flow architecture operating the target deep learning model. The intermediate representation of the customized architecture is close to an underlying operation and has relatively high operation efficiency.

The operator in the intermediate representation of the data flow computation graph represents a minimum operation unit that can be executed under the data flow architecture. In the intermediate representation of the customized architecture, the minimum operation unit may be divided according to a module. For example, in the intermediate representation of the data flow computation graph, there are four types of operator: B, C, D and E. An operation relationship between operators is that (B+C) is operated first and then (B+C+D+E) is operated. The intermediate representation of the customized architecture may be that a first module operates (B+C) and a second module operates (D+E). In a design, the first module and the second module may perform the computation simultaneously, reducing the computation time and improving the efficiency.

In S140, a converted target data flow network model corresponding to the target deep learning model is obtained according to the intermediate representation of the customized architecture.

In an embodiment, the target data flow network model is the deep learning model operating under the data flow architecture, and the intermediate representation of the customized architecture may be regarded as a computation graph of the target data flow network model which includes both types of operator and a corresponding data parameter of the target data flow network model and a connection relationship between operators of the target data flow network model. The target deep learning model can be operated according to the intermediate representation of the customized architecture so that the deep learning model developed based on the instruction set architecture is converted to operate under the data flow architecture.

In the embodiments of the present application, the target deep learning model is parsed into the intermediate representation of the instruction set computation graph; the intermediate representation of the instruction set computation graph is converted into the intermediate representation of the data flow computation graph; the intermediate representation of the data flow computation graph is adjusted to the intermediate representation of the customized architecture; and the converted target data flow network model corresponding to the target deep learning model is obtained according to the intermediate representation of the customized architecture. Therefore, the deep learning model developed based on the instruction set architecture is converted to operate under the data flow architecture. The intermediate representation of the instruction set computation graph, the intermediate representation of the data flow computation graph and the intermediate representation of the customized architecture are used for describing the deep learning model, which may make a design more flexible through a tradeoff in readability and execution efficiency according to an actual requirement.

In an embodiment, the target deep learning model includes the first operator granularity, the intermediate representation of the instruction set computation graph includes the second operator granularity, and the intermediate representation of the data flow computation graph includes the third operator granularity.

In an embodiment, the first operator granularity is the same as the second operator granularity.

In an embodiment, the second operator granularity is less than the third operator granularity.

In an embodiment, the intermediate representation of the instruction set computation graph further includes the first operator, and the intermediate representation of the data flow computation graph further includes the second operator. In an embodiment, the third operator granularity is obtained for the second operator.

In an embodiment, multiple first operators form the second operator through the fusion and conversion.

In embodiment one of the present application, the target deep learning model is parsed into the intermediate representation of the instruction set computation graph; the intermediate representation of the instruction set computation graph is converted into the intermediate representation of the data flow computation graph; the intermediate representation of the data flow computation graph is adjusted to the intermediate representation of the customized architecture; and the converted target data flow network model corresponding to the target deep learning model is obtained according to the intermediate representation of the customized architecture. Therefore, the deep learning model developed based on the instruction set architecture is converted to operate under the data flow architecture. The intermediate representation of the instruction set computation graph, the intermediate representation of the data flow computation graph and the intermediate representation of the customized architecture are used for describing the deep learning model, which may make the design more flexible through the tradeoff in the readability and execution efficiency according to the actual requirement.

### Embodiment Two

FIG. 2 is a structure diagram of a conversion apparatus for a deep learning model according to an embodiment of the present application. The present embodiment may be applicable to a case in which a deep learning model developed based on an instruction set architecture is input into a chip based on a data flow architecture to operate. The apparatus may be implemented in software and/or hardware and integrated on a server. The conversion apparatus for a deep learning model according to the embodiment of the present application can perform the conversion method for a deep learning model according to any embodiment of the present application and has function modules and effects corresponding to the performed method. For content not described in embodiment two of the present application, reference may be made to description in any method embodiment of the present application.

As shown in FIG. 2, a conversion apparatus 200 for a deep learning model according to the embodiment of the present application includes a target deep learning model parsing module 210, an instruction set computation graph intermediate representation conversion module 220, a data flow computation graph intermediate representation adjustment module 230 and a target data flow network model generation module 240.

The target deep learning model parsing module 210 is configured to parse a target deep learning model into an intermediate representation of an instruction set computation graph.

The instruction set computation graph intermediate representation conversion module 220 is configured to convert the intermediate representation of the instruction set computation graph into an intermediate representation of a data flow computation graph.

The data flow computation graph intermediate representation adjustment module 230 is configured to adjust the intermediate representation of the data flow computation graph to an intermediate representation of a customized architecture.

The target data flow network model generation module 240 is configured to obtain a converted target data flow network model corresponding to the target deep learning model according to the intermediate representation of the customized architecture.

In an embodiment, each of the target deep learning model parsing module 210, the instruction set computation graph intermediate representation conversion module 220 and the data flow computation graph intermediate representation adjustment module 230 is an independent module.

In an embodiment, each of the target deep learning model parsing module 210, the instruction set computation graph intermediate representation conversion module 220 and the data flow computation graph intermediate representation adjustment module 230 is an independent module.

In a case where one of the target deep learning model parsing module 210, the instruction set computation graph intermediate representation conversion module 220 and the data flow computation graph intermediate representation adjustment module 230 is modified, operating logics of other modules are not affected. For example, if the target deep learning model needs to be replaced and a target deep learning model after the replacement and the target deep learning model before the replacement are developed based on different deep learning frameworks, a related logic of the target deep learning model parsing module 210 is modified to correspond to a deep learning framework corresponding to the target deep learning model after the replacement, and the instruction set computation graph intermediate representation conversion module 220 and the data flow computation graph intermediate representation adjustment module 230 may remain constant and continue to be used. If the target data flow network model needs to be varied, a related variation is made to the data flow computation graph intermediate representation adjustment module 230, and the target deep learning model parsing module 210 and the instruction set computation graph intermediate representation conversion module 220 may remain constant and continue to be used.

In an embodiment, the target deep learning model includes first operator granularity, the intermediate representation of the instruction set computation graph includes second operator granularity, and the intermediate representation of the data flow computation graph includes third operator granularity.

In an embodiment, the first operator granularity is the same as the second operator granularity.

In an embodiment, the second operator granularity is less than the third operator granularity.

In an embodiment, the intermediate representation of the instruction set computation graph further includes a first operator, and the intermediate representation of the data flow computation graph further includes a second operator.

In an embodiment, multiple first operators form the second operator through fusion and conversion.

In the embodiments of the present application, the target deep learning model parsing module, the instruction set computation graph intermediate representation conversion module, the data flow computation graph intermediate representation adjustment module and the target data flow network model generation module are included so that the deep learning model developed based on the instruction set architecture is converted to operate under the data flow architecture. The intermediate representation of the instruction set computation graph, the intermediate representation of the data flow computation graph and the intermediate representation of the customized architecture are used for describing the deep learning model, which may make a design more flexible through a tradeoff in readability and execution efficiency according to an actual requirement. Each of the target deep learning model parsing module, the instruction set computation graph intermediate representation conversion module and the data flow computation graph intermediate representation adjustment module is the independent module, increasing expansibility of the conversion apparatus for a deep learning model and improving a development speed.

### Embodiment Three

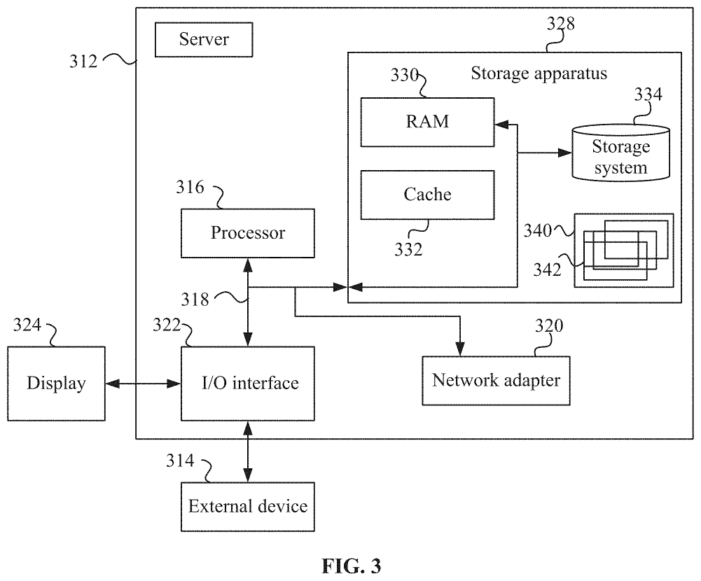

FIG. 3 is a structure diagram of a server according to embodiment three of the present application. FIG. 3 shows a block diagram of an exemplary server 312 applicable to implementing implementations of the present application. The server 312 shown in FIG. 3 is only an example.

As shown in FIG. 3, the server 312 takes a form of a general-purpose server. Components of the server 312 may include one or more processors 316, a storage apparatus 328 and a bus 318 connecting different system components (including the storage apparatus 328 and the one or more processors 316).

The bus 318 represents one or more of several types of bus structures including a storage apparatus bus or a storage apparatus controller, a peripheral bus, a graphics acceleration port, a processor, or a local bus using any one of multiple bus structures. For example, such architectures include an Industry Standard Architecture (ISA) bus, a Micro Channel Architecture (MCA) bus, an enhanced ISA bus, a Video Electronics Standards Association (VESA) local bus and a Peripheral Component Interconnect (PCI) bus.

The server 312 includes multiple computer system readable media. Such media may be available media that can be accessed by the server 312, including volatile and non-volatile media, and removable and non-removable media.

The storage apparatus 328 may include a computer system readable medium in the form of volatile memory, such as a random-access memory (RAM) 330 and/or a cache 332. The server 312 may include other removable/non-removable and volatile/non-volatile computer system storage media. Just for example, a storage system 334 may be configured to perform reading and writing on a non-removable and non-volatile magnetic medium (not shown in FIG. 3 and usually referred to as a “hard disk driver”). Although not shown in FIG. 3, it is feasible to provide not only a magnetic disk driver for performing reading and writing on a removable non-volatile magnetic disk (for example, a “floppy disk”), but also an optical disk driver for performing reading and writing on a removable non-volatile optical disk, such as a compact disc read-only memory (CD-ROM), a digital video disc-read only memory (DVD-ROM) or other optical media. In such cases, each driver may be connected to the bus 318 via one or more data media interfaces. The storage apparatus 328 may include at least one program product having a group of program modules (for example, at least one program module). Such program modules are configured to perform functions of multiple embodiments of the present application.

A program/utility 340 having a group of program modules 342 (at least one program module 342) may be stored in, for example, the storage apparatus 328. Such program modules 342 include an operating system, one or more application programs, other program modules and program data. Each or some combination of such examples may include an implementation of a network environment. The program modules 342 generally perform functions and/or methods in the embodiments of the present application.

The server 312 may communicate with one or more external devices 314 (such as a keyboard, a pointing server and a display 324), and may also communicate with one or more servers that enable a user to interact with the server 312, and/or communicate with a server (such as a network card or a modem) that enables the server 312 to communicate with one or more other computing servers. Such communication may be performed through an input/output (I/O) interface 322. Moreover, the server 312 may also communicate with one or more networks (such as a local area network (LAN), a wide area network (WAN) and/or a public network such as the Internet) through a network adapter 320. As shown in FIG. 3, the network adapter 320 communicates with other modules of the server 312 via the bus 318. Although not shown in FIG. 3, other hardware and/or software modules may be used in conjunction with the server 312. The other hardware and/or software modules include microcode, a server driver, a redundant processor, external disk drives array, a redundant arrays of independent disks (RAID) system, a tape driver, a data backup storage system and the like.

The one or more processors 316 executes a program stored in the storage apparatus 328 to perform multiple functional applications and data processing, for example, to perform the method according to any embodiment of the present application. The method may include the steps below. A target deep learning model is parsed into an intermediate representation of an instruction set computation graph.

The intermediate representation of the instruction set computation graph is converted into an intermediate representation of a data flow computation graph.

The intermediate representation of the data flow computation graph is adjusted to an intermediate representation of a customized architecture.

A converted target data flow network model corresponding to the target deep learning model is obtained according to the intermediate representation of the customized architecture.

### Embodiment Four

Embodiment four of the present application further provides a computer-readable storage medium storing a computer program, where the computer program, when executed by a processor, implements the method according to any embodiment of the present application. The method may include the steps below.

A target deep learning model is parsed into an intermediate representation of an instruction set computation graph.

The intermediate representation of the instruction set computation graph is converted into an intermediate representation of a data flow computation graph.

The intermediate representation of the data flow computation graph is adjusted to an intermediate representation of a customized architecture.

A converted target data flow network model corresponding to the target deep learning model is obtained according to the intermediate representation of the customized architecture.

A computer storage medium in the embodiments of the present application may use a combination of one or more computer-readable media. The computer-readable media may be computer-readable signal media or computer-readable storage media. The computer-readable storage medium may be, for example, but is not limited to, an electrical, magnetic, optical, electromagnetic, infrared, or semiconductor system, apparatus, or device, or a combination thereof. Examples (a non-exhaustive list) of the computer-readable storage medium include an electrical connection having one or more wires, a portable computer magnetic disk, a hard disk, an RAM, a read-only memory (ROM), an erasable programmable read-only memory (EPROM) or a flash memory, an optical fiber, a portable CD-ROM, an optical storage device, a magnetic storage device, or a suitable combination thereof. In this document, the computer-readable storage medium may be multiple tangible media containing or storing a program. The program may be used by or used in conjunction with an instruction execution system, apparatus or device.

A computer-readable signal medium may include a data signal propagated in a baseband or as part of a carrier. Computer-readable program codes are carried in the data signal. The data signal propagated in this manner may be in multiple forms and includes an electromagnetic signal, an optical signal or a suitable combination thereof. The computer-readable signal medium may also be any computer-readable medium that is not a computer-readable storage medium and that can send, propagate or transmit a program used by or used in conjunction with an instruction execution system, apparatus or device.

The program codes contained in the computer-readable medium may be transmitted in a suitable medium, including a wireless medium, a wire, an optical cable, radio frequency (RF) or a suitable combination thereof.

Computer program codes for performing the operations of the present application may be written in one or more programming languages or a combination thereof, the programming languages including object-oriented programming languages such as Java, Smalltalk and C++ and further including conventional procedural programming languages such as C programming language or similar programming languages. The program codes may be executed entirely or partially on a user computer, as a separate software package, partially on the user computer and partially on a remote computer, or entirely on the remote computer or terminal. In the case where the remote computer is involved, the remote computer may be connected to the user computer via multiple types networks including an LAN or a WAN, or may be connected to an external computer (for example, via the Internet through an Internet service provider).

What is claimed is:

1. A conversion method for a deep learning model, comprising:
parsing a target deep learning model into an intermediate representation of an instruction set computation graph;
converting the intermediate representation of the instruction set computation graph into an intermediate representation of a data flow computation graph;
adjusting the intermediate representation of the data flow computation graph to an intermediate representation of a customized architecture; and
obtaining a converted target data flow network model corresponding to the target deep learning model according to the intermediate representation of the customized architecture.

2. The method according to claim 1, wherein the target deep learning model comprises a first operator granularity, the intermediate representation of the instruction set computation graph comprises a second operator granularity, and the intermediate representation of the data flow computation graph comprises a third operator granularity.

3. The method according to claim 2, wherein the first operator granularity is the same as the second operator granularity.

4. The method according to claim 2, wherein the second operator granularity is less than the third operator granularity.

5. The method according to claim 2, wherein the intermediate representation of the instruction set computation graph further comprises a first operator, and the intermediate representation of the data flow computation graph further comprises a second operator.

6. The method according to claim 5, wherein a plurality of first operators form the second operator through fusion and conversion.

7. A conversion apparatus for a deep learning model, comprising:
one or more processors, and
a storage apparatus configured to store one or more programs;
wherein the one or more programs, when executed by the one or more processors, cause the one or more processors to implement:
parsing a target deep learning model into an intermediate representation of an instruction set computation graph;
converting the intermediate representation of the instruction set computation graph into an intermediate representation of a data flow computation graph;
adjusting the intermediate representation of the data flow computation graph to an intermediate representation of a customized architecture; and
obtaining a converted target data flow network model corresponding to the target deep learning model according to the intermediate representation of the customized architecture.

8. The apparatus according to claim 7, wherein the target deep learning model comprises a first operator granularity, the intermediate representation of the instruction set computation graph comprises a second operator granularity, and the intermediate representation of the data flow computation graph comprises a third operator granularity.

9. A server, comprising:
one or more processors, and
a storage apparatus configured to store one or more programs;
wherein the one or more programs, when executed by the one or more processors, cause the one or more processors to implement a conversion method for a deep learning model, wherein the conversion method comprises:
parsing a target deep learning model into an intermediate representation of an instruction set computation graph;
converting the intermediate representation of the instruction set computation graph into an intermediate representation of a data flow computation graph;
adjusting the intermediate representation of the data flow computation graph to an intermediate representation of a customized architecture; and
obtaining a converted target data flow network model corresponding to the target deep learning model according to the intermediate representation of the customized architecture.

10. A non-transitory computer-readable storage medium storing a computer program, wherein the computer program, when executed by a processor, implements the conversion method for a deep learning model according to claim 1.

11. The apparatus according to claim 8, wherein the first operator granularity is the same as the second operator granularity.

12. The apparatus according to claim 8, wherein the second operator granularity is less than the third operator granularity.

13. The apparatus according to claim 8, wherein the intermediate representation of the instruction set computation graph further comprises a first operator, and the intermediate representation of the data flow computation graph further comprises a second operator.

14. The apparatus according to claim 13, wherein a plurality of first operators form the second operator through fusion and conversion.
